(19) United States
(12) Patent Application Publication
(10) Pub. No.: US 2017/0131247 A1
(43) Pub. Date: May 11, 2017

(54) Minimal Spanning Trees for Extracted Ion Chromatograms

(71) Applicant: Thermo Finnigan LLC, San Jose, CA (US)

(72) Inventor: Paul R. GAZIS, Mountain View, CA (US)

(73) Assignee: Thermo Finnigan LLC

(21) Appl. No.: 14/936,634

(22) Filed: Nov. 9, 2015

(51) Int. Cl. G01N 30/86; G01N 30/72; H01J 49/00; G01N 30/96

(52) U.S. Cl. CPC G01N 30/8617; G01N 30/96; G01N 30/72; H01J 49/0036

(57) ABSTRACT

A method for generating an extracted ion chromatogram (XIC) from mass spectrometry data is disclosed. Mass spectrometry data are received comprised of a plurality of data points, each data point representing a measured ion intensity at a mass to charge ratio at a chromatographic retention time and these data are filtered to produce a filtered dataset. A minimal spanning tree is then generated connecting the data points of the filtered dataset and tree branches are pruned in accordance with a specified length threshold to yield one or more sub-trees. The sub-trees are then interpreted as a set of XICs and displayed on a display device.

### FIELD OF THE INVENTION

This invention relates generally to the field of liquid chromatography and mass spectrometry (LC/MS) and more specifically, to a method of data interpretation, selection and generation of an extracted ion chromatogram.

### BACKGROUND OF THE INVENTION

Liquid chromatography/mass spectrometry (LC/MS) is widely used to identify and characterize a broad range of chemical and biological samples, from small molecules, such as drugs and drug metabolites, to large molecules such as oligonucleotides, polypeptides and proteins. In LC/MS, liquid chromatography (LC) is used to separate a sample into one or more components or into smaller mixtures of components that may be subsequently analyzed by a mass spectrometer.

Ion chromatograms of sample mixtures are often complicated by the presence of peaks associated with components outside the mass range of interest. For this reason, it is common to select ion chromatographic data from a restricted mass range to produce an extracted ion chromatogram (XIC or EIC) of intensity (I) or relative abundance (RA) versus retention time (RT).

The extraction algorithm used to generate XICs should be objective, insensitive to noise, require a minimum of user-defined parameters, and be able to tolerate modest variations and/or slight drifts in mass over the course of a mass spectroscopic measurement.

Two standard approaches to generating XICs are to use a priori knowledge about the target involved to determine a mass range, or to apply an intensity threshold to a plot of intensity versus retention time and the mass to charge ratio (m/z) under the assumption that the remaining data points will line up in rows of constant m/z. Many existing extraction schemes are refinements of these two approaches. Both of these approaches suffer from disadvantages. It may not always be possible to obtain the a prioi knowledge necessary to apply the first scheme. The second scheme can prove excessively sensitive to the choice of an intensity threshold, and can be complicated by cases where the data does not line up in well-defined rows. Against this background, there remains a need in the mass spectrometry art for an improved method of generating XICs that avoids the deficiencies of the above known techniques.

### SUMMARY OF THE INVENTION

In accordance with an illustrated embodiment of the present invention, a method for generating an extracted ion chromatogram from mass spectrometry data is described by the use of minimal spanning trees (MST). The MST technique described herein provides XICs without the need for any a priori knowledge of the target and without being excessively sensitive to the choice of an intensity threshold. An illustrative embodiment of the present invention receives mass spectrometry data having more than one data point. Each mass spectrometry data point represents three values; a measured ion intensity, a mass to charge ratio (m/z) and a chromatographic retention time. The mass spectrometry data is then filtered to give a filtered mass spectrometry dataset. The filtered dataset is then used to generate a minimal spanning tree (MST) where all of the data points are connected by the shortest possible connecting path. Longer minimal spanning tree branches that join the data points may then be cut or pruned in accordance with a specified length threshold to provide one or more data point sub-trees. The specified length threshold may be input by the user and the remaining sub-trees may be interpreted as a set of extracted ion chromatograms (XICs). Advantages that this method may provide over the prior art include:
1) There is no requirement of any a priori knowledge regarding a target mass.
2) There is no dependence on any ad hoc decisions related to mass tolerance and/or spacing between XICs.
3) There is no requirement that the data lines up in well-defined rows.

During the filtering step of the mass spectrometry data, the data point(s) with maximum observed intensity may be determined in order to set a noise threshold. This can be achieved by multiplying the maximum observed intensity by a relative intensity threshold to determine an absolute intensity threshold below which data points may be discarded. The data points can then be plotted in a retention time dimension and in a m/z dimension.

Scaling of the m/z or retention time axes may play a role in sub-tree formation as branches that are pruned between neighboring data points may be interchanged resulting in different sub-trees being formed. Therefore, a scaling factor may be applied to one of the axes, preferably in the m/z direction, that spaces out the data points in this direction.

### BRIEF DESCRIPTION OF THE FIGURES

FIG. 1 shows a symbolic depiction of an LC/MS system (interconnected boxes, respectively labeled as “Sample”, “LC”, “MS”, “Output” and “Data/control system).

FIG. 2 shows a flowchart depicting the component steps of the MST method.

FIG. 3A shows a depiction of LC/MS data for a set of buspirone data.

FIG. 3B shows an example of an XIC for the data in the upper panel for the mass range between 124.0 and 124.1.

FIG. 4 shows an arbitrary spanning tree for a set of 20 points for an arbitrary set of x- and y-coordinates.

FIG. 5 shows the minimal spanning tree for the 20 points in FIG. 4.

FIG. 6. shows sub-trees of the minimal spanning tree in FIG. 5.

FIG. 7. shows a scatter plot in retention time and m/z of points that lie above an intensity threshold for a set of buspirone data.

FIG. 8. shows a minimal spanning tree for the set of buspirone data in FIG. 7.

FIG. 9. shows sub-trees for the minimal spanning tree in FIG. 8.

FIG. 10A shows a generic total ion chromatogram.

FIG. 10B shows an extracted ion chromatogram from FIG. 10A.

FIG. 11A shows another total ion chromatogram.

FIG. 11B shows an extracted ion chromatogram from FIG. 11A.

FIG. 11C shows a mass spectrum of the main peak from FIG. 11B.

### DETAILED DESCRIPTION

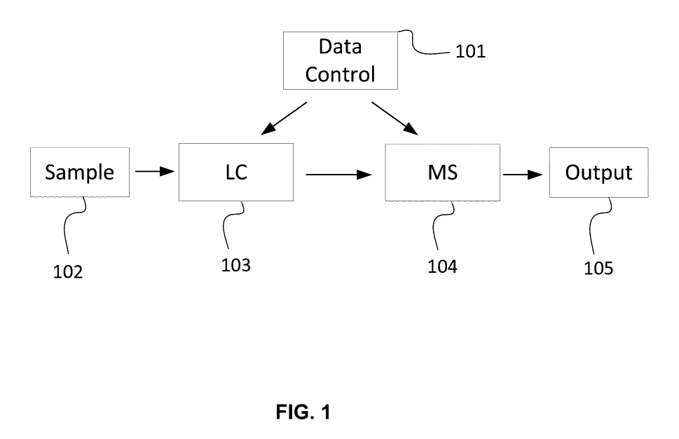

The following description is presented to enable a person skilled in the art to make and use the invention, and is provided in the context of a particular application and its requirements. Various modifications to the described embodiments herein will be readily apparent to those skilled in the art and the generic principles may be applied to other embodiments. Thus, the present invention is not intended to be limited to the embodiments and examples shown but is to be given the widest possible scope in accordance with the features and principles shown and described. The particular features and advantages of the invention will become more apparent with reference to the appended FIGS. 1-11, taken in conjunction with the following description.

As used herein and unless the context indicates otherwise, singular forms of the terms are to be construed as including the plural form and vice versa. For instance, unless the context indicates otherwise, a singular reference, such as “a” or “an” means “one or more”. Throughout the description and claims of this specification, the words “comprise”, “including”, “having” and “contain” and variations of these words, for example “comprising” and “comprises” etc, mean “including but not limited to”, and are not intended to (and do not) exclude other components. It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example”, “e.g.” and like language) provided herein, is intended merely to better illustrate the invention and does not indicate a limitation on the scope of the invention unless otherwise claimed. No language in the specification should be construed as indicating any non-claimed element as essential to the practice of the invention. Steps described in this specification may be performed in any order or simultaneously unless stated or the context requires otherwise. All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

Preferred embodiments of the present invention provide a method for generating an extracted ion chromatogram (XIC or EIC) from mass spectrometry or LC-MS data.

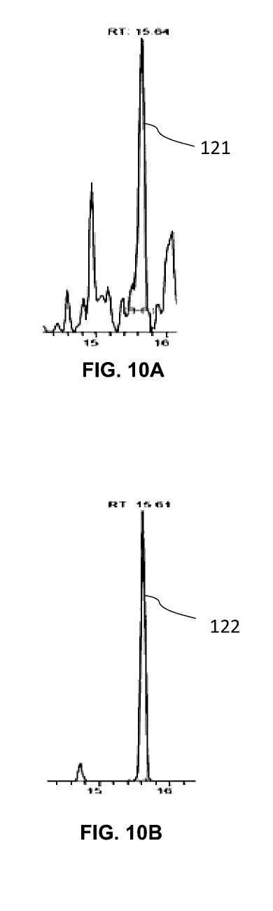

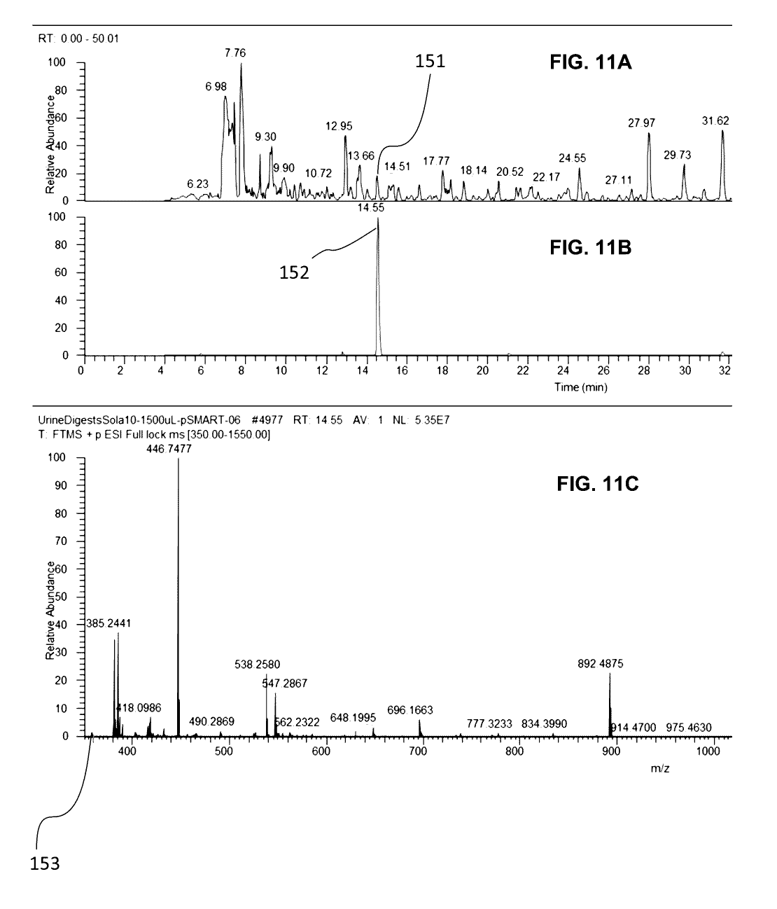

Mass spectrometers are often used to compile a three dimensional data array of intensity (I) or relative abundance (RA) versus mass to charge ratio (m/z) versus retention time (RT) in MS, LC-MS or LC-MSn. A TIC is a two dimensional slice through this 3D data set that displays intensity or relative abundance of all detected ions versus RT. An XIC is a slice through the 3D data set that displays intensity versus RT for only a limited m/z window. For example, in a MS system that had a relatively low resolution mass analyzer such as a standard quadrupole MS or an ion trap MS, if the ion of interest had a nominal m/z value of 301.0 Daltons, a typical XIC might be generated between 300.5 to 301.5 Daltons for analyte quantification (a major use of MS or LC-MS instruments). FIG. 10A shows an generic total ion chromatogram (TIC) denoting the total intensity of all detected ions of varying m/z (for example, 50 to 2000 Daltons) detected by the mass spectrometer over a given retention time showing the base peak 121. The generation of an XIC is vital in mass spectrometry, especially in quantitative mass spectrometry in order to determine an accurate amount of a particular sample component, normally determined using the height or more accurately integration of the area of a particular analyte peak. FIG. 10B shows an XIC that represents, for example, only a single Dalton span (e.g. 300.5 to 301.5) represented by peak 122. It can clearly be seen from FIG. 10B that the XIC is the critical component necessary for determining the amount of a particular analyte of interest in MS or LC-MS, therefore the quality of a XIC is of paramount importance for accurate analyte determination. The present invention is directed towards the production of more accurate XICs in mass spectrometry. Another example of a TIC is shown in FIG. 11A where the peak of interest is 151 at retention time 14.51 min. The XIC corresponding to peak 151 is shown as peak 152 in FIG. 11B. FIG. 11C shows the mass spectrum for peak 152 which aides in the identity of the analyte represented by peak 152 in FIG. 11B.

FIG. 1 shows a LC/MS system in which the methods of the present invention may be implemented. The LC/MS system includes a liquid chromatograph (LC) 103, a mass spectrometer (MS) 104, and a data/control system 101. The LC 103 may be equipped with a chromatographic column that acts to separate or partially separate analytes within a sample 102, such that different component analytes can be eluted from the column and may be introduced to the inlet of a mass spectrometer 104 at different times. The eluate of the LC column passes to the mass spectrometer 104, which operates to ionize the analytes and to measure the mass-to-charge ratios (m/z) of the ions produced.

A data control system FIG. 1, 101 may be configured to manage the operation of an LC 103 and a mass spectrometer 104, and to store and process data generated by the mass spectrometer 104 and/or the LC 103 with an output 105 that may comprise of a total ion current chromatogram and/or accompanying mass spectra. The data control system 101 may include both hardware and software logic, and the functions of the data control system 101 may be distributed among multiple physical devices, including general-purpose and specialized processors, storage devices, and volatile and non-volatile memory. The data control system 101 is preferably equipped with input and output devices for accepting user input and for displaying results.

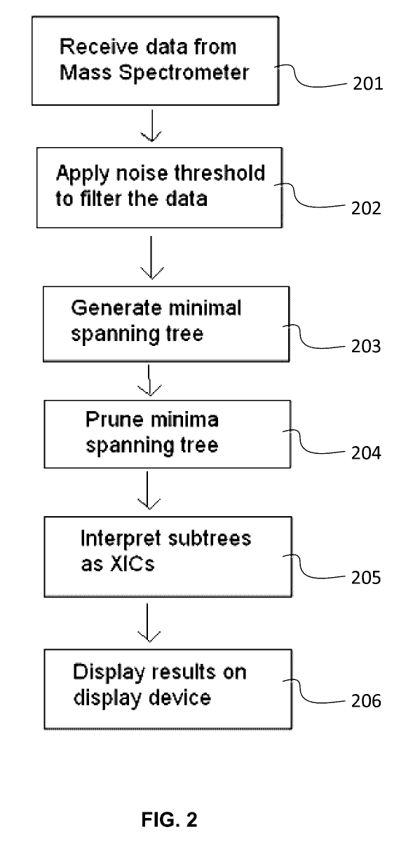

FIG. 2 is a schematic flowchart depicting the component steps of a method of processing mass spectrometry data to generate a set of XICs, implemented in accordance with a preferred embodiment of the present invention. In the initial step 201, the mass spectrometry data is received for processing by the data control system 101.

In step 202 of FIG. 2, the mass spectrometry data is filtered, for example, by applying a noise threshold, to produce as output, a filtered data set. In step 203 a minimal spanning tree (MST) may be generated connecting data points of the filtered dataset. In step 204, branches of the minimal spanning tree that exceed a specified length threshold may be pruned to yield at least one sub-tree (a branch is defined here as a contiguous pathway that connects a succession of data points). In step 205 at least one of these sub-trees may be interpreted as a set of extracted ion chromatograms. In step 206 the resulting XICs are displayed on a display device. These steps in FIG. 2 are described in detail below:

In the initial step 201, the mass spectrometry data is received for processing by the data control system 101. The LC/MS instrument then produces an array of data points, each data point having values representing time, m/z, and intensity. These data may either be centroid data, in which case each spectrum is represented as a set of individual peaks, or profile data, in which case each spectrum is represented as a continuous profile of points.

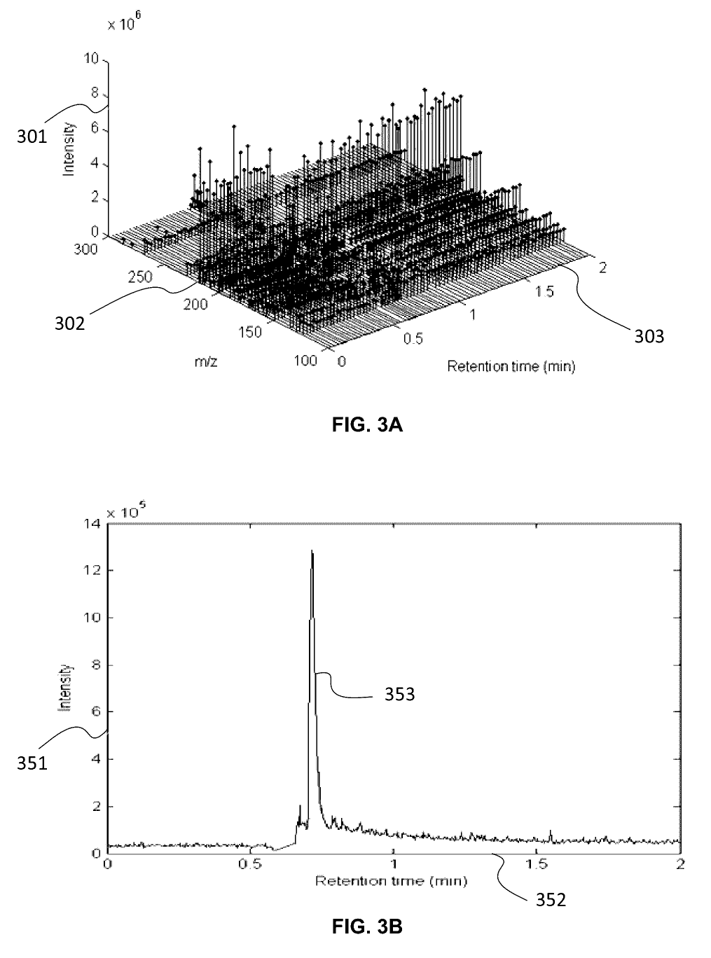

A data set may be represented as a 3-dimensional plot, as shown in FIG. 3A, using m/z 302, intensity 301 and retention time 303. A total ion chromatogram (TIC), proportional to the signal in retention time returned by the LC portion of the instrument, is the total intensity 301 of each spectrum plotted versus retention time 303.

An extracted ion chromatogram (XIC) is generated by restricting the m/z range 302 to a narrow region of interest. FIG. 3B, shows an example of an XIC for the m/z range centered on m/z=124.05. This was generated by selecting data from the FIG. 3A between the m/z values of 124.00 and 124.10. It is not unusual for this chosen m/z region to be associated with a target component, for example, shown in FIG. 3B as peak 353. When the target mass is already known, this is straightforward and trivial to implement. However, this may not be the case, and an analysis scheme will be required to identify target mass candidates. Ideally, this scheme should be objective, robust, and comparatively insensitive to control parameters such as resolution and threshold.

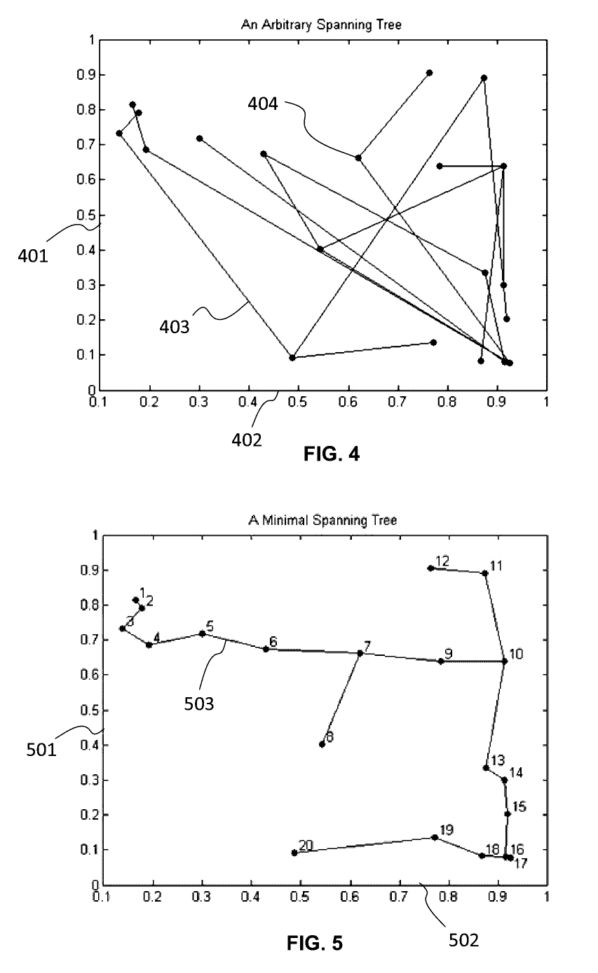

In step 203 (FIG. 2), a minimal spanning tree is generated connecting data points of the filtered dataset. Minimal spanning trees are a concept derived from graph theory. In graph theory, a ‘tree’ is a collection of connections or ‘edges’ that connect a set of points. A ‘spanning tree’ is any tree that connects all of the points in a set. FIG. 4 shows an arbitrary spanning tree 403 for a set of 20 points, with arbitrary axes 401 and 402 and with an exemplary point shown 404. A minimal spanning tree is the shortest possible spanning distance between all of the points, for example, the tree with the smallest possible sum for all of the combined edges. FIG. 5, shows the minimal spanning tree 503 for the same set of 20 data points as shown in FIG. 4.

Minimal spanning trees have several useful properties. They may group clusters of nearby points into sub-trees. If the separation between data points along one axis is typically less than the separation between data points along any other orthogonal axes used in the minimal spanning tree, these sub-trees will tend to form ‘branches’ that run quasi-parallel to this preferred axis. For LC/MS applications, applying a scaling factor in the m/z dimension 302 (FIG. 3A) can ensure that distances between the data points in the m/z direction are typically greater than distances in the retention time dimension 303, and the branches that run quasi-parallel to it will define XICs. The same effect would be realized by applying a negative scaling factor to the retention time dimension 303. This can be accomplished by scaling m/z by a small multiple (for example, 2 to 5×) of the retention time separation between successive scans divided by the minimum expected m/z separation (typically 0.1-1 Da) between adjacent XICs. Smaller or larger scaling factors may also be used.

Several well-established algorithms, such as Kruskal's algorithm [Kruskal. J. B., On the Shortest Spanning Subtree of a Graph and the Traveling Salesman Problem, in Proceedings of the American Mathematical Society, Vol 7, No. 1, pp. 48-50, 1956] and Prim's algorithm [Prim, R. C., Shortest connection networks and some generalizations, in Bell System Technical Journal, 36, pp. 1389-1401, 1957], exist to generate minimal spanning trees and these publications are herein incorporated by reference. These algorithms all have the desirable feature that they are automatic, objective, and do not generally depend on user-defined parameters.

Input to step 203 in FIG. 2 involves the array of intensity measurements versus retention time and m/z produced by step 202. Output from step 203 is a data structure that consists of a set of sub-structures or elements, each sub-structure or element contains a set of numbers that defines a connection between 2 data points in the tree. Each element of the data structure describes one branch of the tree, and contains the ID numbers of the two endpoints and the length of that branch in the following format:

[First:Endpoint Second_Endpoint:Length]

These elements and the points they contain need not be in any particular order. For example, in the tree shown in FIG. 5, point 5 is associated with the following data element:

[5:6:0.1512]

By linking together branches that share endpoints, it is possible to reconstruct part or all of the tree. For example, the portion of the tree in FIG. 5 that contains points 5, 6, 7, and 9, is described by the following data elements:

[5:6:0.1512]

[9:7:0.1838]

[7:6:0.2112]

[7:8:0.2990]

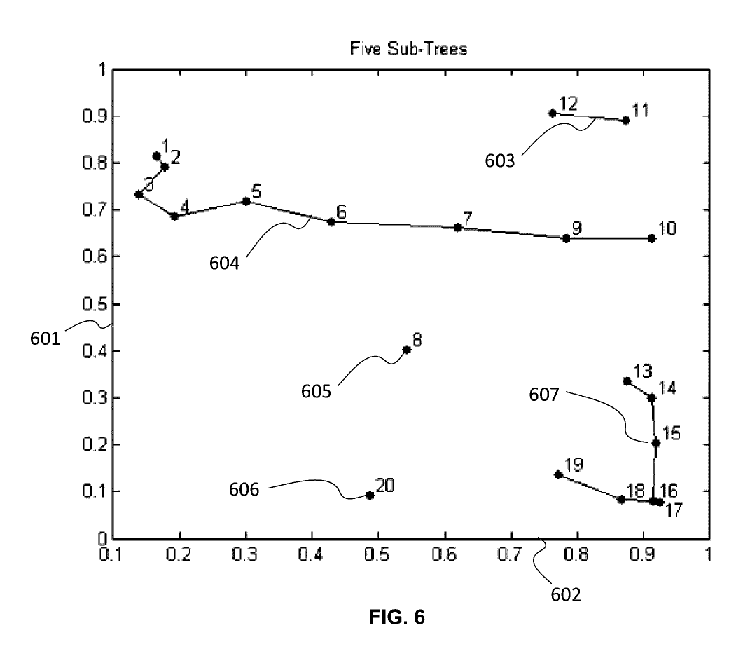

A minimal spanning tree can be divided into two or more sub-trees by pruning branches whose length exceeds a threshold value. FIG. 6, has axes with arbitrary units 601 and 602 and shows five sub-trees (603, 604, 605, 606, and 607) produced by pruning branches of the minimal spanning tree shown in FIG. 5 whose length exceeds 0.27 arbitrary units. Note that two of these sub-trees—points 605 and 606—contain only a single point each.

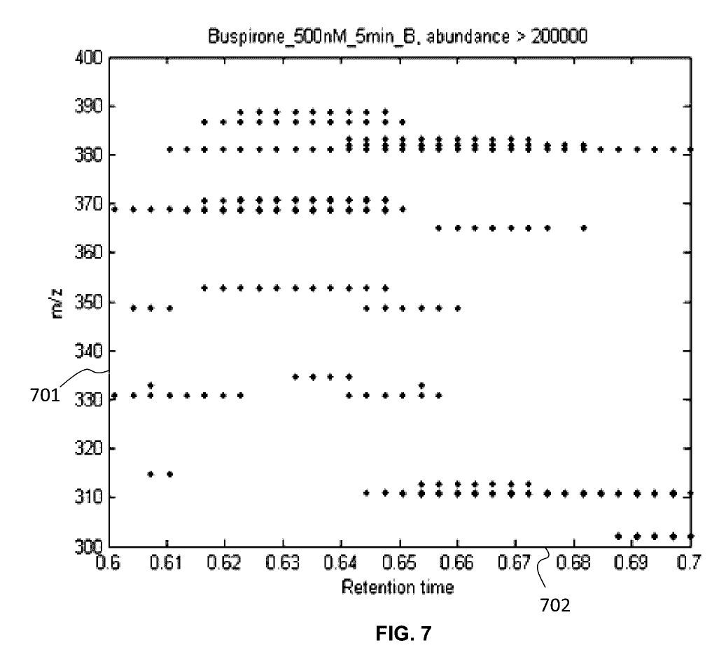

FIG. 7, shows a scatter plot of points that lie above a threshold intensity for a set of buspirone data. Individual components may reappear at similar m/z values (similar m/z values could be m/z values that have a difference of less than one atomic mass unit or amu) at successive retention times, but the m/z ranges that are associated with specific components are not clear from this scatter plot.

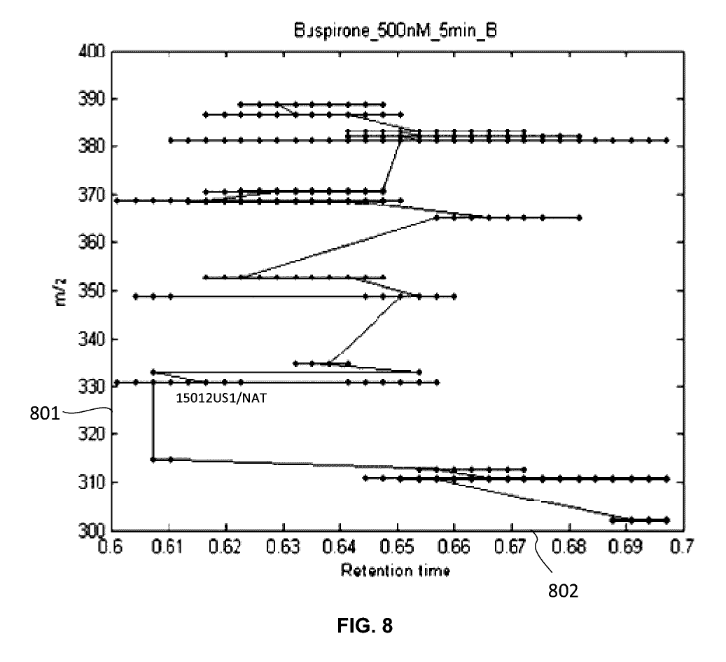

FIG. 8, with m/z axis 801 and retention time axis 802 shows the results of applying a minimal spanning tree to the set of buspirone data in the FIG. 7. The connections between the data points at similar m/z may be shorter than the connections between points with significantly different m/z values. This will facilitate the pruning process described in the next step.

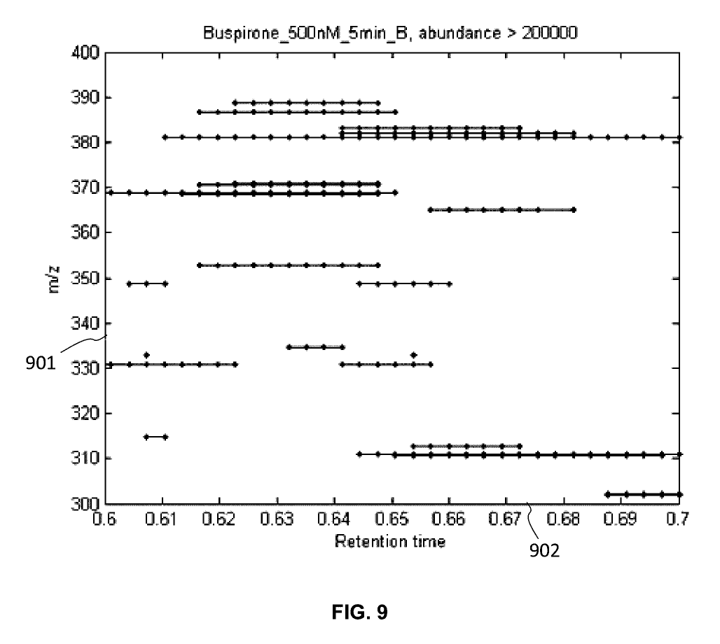

In step 204, FIG. 2, branches of the minimal spanning tree that exceed a specified length threshold are pruned to yield at least one sub-tree. As with the noise threshold described in step 202, the precise choice of a length threshold is not critical, for the results are comparatively insensitive to this parameter. FIG. 9, with axes m/z 901 and retention time 902 shows the set of sub-trees produced by pruning the minimal spanning tree shown in FIG. 8.

This algorithm provides a reliable and objective means of resolving ambiguities associated with the scatter plot in FIG. 7. The data between m/z of 381.0 and 384.0 are assigned to three distinct XICs for which the spacing between data points within each XIC is guaranteed to be less than the separation between XICs. The data at m/z of 330.5 are assigned to two XICs with different retention times that could be associated with different components. Input to step 4 involves the data structure returned by step 3 and output is a collection of similar data structures, each of which describes one sub-tree.

In FIG. 2, step 205, at least one of the sub-trees is interpreted as a set of extracted ion chromatograms. In most cases, each sub-tree will comprise of a succession of retention time-m/z-intensity triplets, one per spectrum, for a succession of spectra. In these cases, the interpretation is straightforward, and the XIC can be constructed by plotting the intensities of these points versus their retention times. In some cases, a sub-tree might contain multiple points from some of its spectra. These will appear as retention time-m/z-intensity triplets with identical values for the retention time. Here the data point with the largest intensity may be used and the other points at that time may be discarded.

In step FIG. 2, 206, the XICs produced in step 205 are displayed on a display device, such as a monitor, or comparable graphical display.

Various modifications to the described embodiments will be readily apparent to those skilled in the art. The generic principles herein may be applied to similar embodiments of the invention described herein. Thus, the present invention is not intended to be limited to the embodiments and examples shown but is to be accorded the widest possible scope in accordance with the features and principles shown and described.

Although exemplary embodiments herein refer to LC-MS applications, the scope and spirit of the invention is not meant to be limited to LC-MS applications. One skilled in the art would readily recognize that the scope of the invention might relate to many other types of mass spectrometry based systems including but not limited to GC-MS, FT-ICR-MS, IR-MS and Maldi-MS and also to areas that generate similar 3D data plots, for example, photo diode array high performance liquid chromatography (PDA-HPLC) which produces absorbance-retention time-wavelength triplet data points.

In describing exemplary embodiments, specific terminology is used where clarity is required. For purposes of description, each specific term is intended to at least include all technical and functional equivalents that operate in a similar manner to accomplish a similar purpose. Additionally, in some instances where a particular exemplary embodiment includes a plurality of method steps, those steps may be replaced with a single step. Likewise, a single step may be replaced with a plurality of steps that serve the same purpose. It will thus be appreciated that those skilled in the art will be able to devise various alternatives that, although not explicitly shown or described herein, embody the principles of the invention and thus are within its spirit and scope.

What is claimed is:

1. A method of generating an extracted ion chromatogram from mass spectrometry data comprising:
(a) receiving the mass spectrometry data comprising a plurality of data points, each data point representing a measured ion intensity at a mass to charge ratio at a chromatographic retention time;
(b) filtering the mass spectrometry data to produce a filtered dataset;
(c) generating a minimal spanning tree connecting data points of the filtered dataset;
(d) pruning branches in the minimal spanning tree that exceed a specified length threshold to yield at least one sub-tree; and,
(e) interpreting the at least one sub-tree as a set of extracted ion chromatograms.

2. The method of claim 1, wherein the step of filtering the mass spectrometry data includes determining the maximum observed intensity, multiplying this by a relative intensity threshold to determine an absolute intensity threshold, and discarding points with intensities less than the absolute intensity threshold.

3. The method of claim 1 further comprising plotting the data points in the filtered data set in two dimensions, a retention time dimension and a m/z dimension.

4. The method of claim 3, further comprising applying a scaling factor to the m/z dimension or to the retention dimension.

5. The method of claim 1, wherein the step of generating a minimal spanning tree further comprises plotting points in the filtered data set in two dimensions, where these dimensions are retention time and m/z, and then applying a Prim algorithm to this plot to generate a minimal spanning tree.

6. The method of claim 1, wherein the step of generating a minimal spanning tree further comprises plotting points in the filtered data set in two dimensions, where the dimensions are retention time and m/z, and then applying a Kruskal algorithm to this plot to generate a minimal spanning tree.

7. The method of claim 1, wherein the specified length threshold is set in accordance with user input and branches of the minimal spanning tree while lengths greater than this threshold are pruned (discarded) to leave a set of subtrees.

8. The method of claim 1, further comprising including one data point per spectrum for a succession of spectra and plotting the intensities of these points versus their retention times, wherein the subtree consists of a succession of retention time-m/z-intensity triplets, and wherein the subtree contains one data point from each of its mass spectra.

9. The method of claim 1, further comprising including a plurality of data points per spectrum for a succession of spectra and plotting the intensities of these points versus their retention times, wherein the subtree consists of a succession of time-m/z-intensity triplets, and wherein the subtree contains multiple data points from some of its mass spectra and using only the data point with the largest intensity and discarding the other data points at that retention time.

10. The method of claim 1, wherein the set of extracted ion chromatograms are displayed graphically as plots of intensity versus retention time.
